(19) United States
(12) Patent Application Publication
(10) Pub. No.: US 2013/0051084 A1
(43) Pub. Date: Feb. 28, 2013

(54) DC-DC CONVERTER

(71) Applicants: Koji Hachiya, Aichi (JP); Yusaku Ido, Gifu (JP); Yasumichi Omoto, Aichi (JP); Masayuki Hanatani, Aichi (JP); Hajime Tamanaha, Aichi (JP)

(72) Inventors: Koji Hachiya, Aichi (JP); Yusaku Ido, Gifu (JP); Yasumichi Omoto, Aichi (JP); Masayuki Hanatani, Aichi (JP); Hajime Tamanaha, Aichi (JP)

(73) Assignee: OMRON AUTOMOTIVE ELECTRONICS CO., LTD., Aichi (JP)

(21) Appl. No.: 13/591,533

(22) Filed: Aug. 22, 2012

(30) Foreign Application Priority Data
Aug. 22, 2011 (JP) 2011-180726

(51) Int. Cl. H02M 3/335

(52) U.S. Cl. 363/21.01

(57) ABSTRACT

The DC-DC converter can calculate an input voltage without being influenced by a commutation time period of a primary-side current of a transformer. The DC-DC converter includes a transformer that has a primary and secondary winding, a switching circuit that is connected to the primary winding of the transformer to perform input voltage switching, a drive circuit that drives the switching circuit, a rectifier circuit that rectifies an AC voltage generated in the secondary winding of the transformer according to the switching operation of the switching circuit, and a controller that evaluates a value of the input voltage and performs predetermined processing based on the value of the input voltage. The controller detects a pulse signal emerging on an input side or an output side of the rectifier circuit, calculates a duty of the pulse signal, and evaluates the value of the input voltage based on the calculated duty.

### BACKGROUND OF THE INVENTION

1. Technical Field

One or more embodiments of the present invention relate to a DC-DC converter, which performs switching of an input voltage on a primary side of a transformer and rectifies an AC voltage generated on a secondary side of the transformer.

2. Related Art

For example, an electric automobile or a hybrid car is provided with a high-voltage battery that drives a running motor and a power supply device that drops a voltage of the battery to supply the dropped voltage to various in-vehicle components. A DC-DC converter is used as the power supply device. The DC-DC converter generally includes a switching circuit that converts a DC voltage into an AC voltage by a switching operation based on a PWM (Pulse Width Modulation) signal, a rectifier circuit that rectifies the AC voltage, a transformer that is provided between the switching circuit and the rectifier circuit, and a smoothing circuit that smoothes the voltage rectified by the rectifier circuit. For example, Domestic Re-publication of PCT International Publication No. 2007/000830 discloses a typical DC-DC converter.

In the DC-DC converter, it is necessary to detect an input voltage, an input current, an output voltage, and an output current in order to always monitor the states of the circuits. The input current can directly be detected by a current sensor or a current transformer. The output current can directly be detected like the input current. Alternatively, the output current may be detected by a calculation using a value of the input current. Domestic Re-publication of PCT International Publication No. 2009/011374 discloses a method for evaluating an output current by a calculation.

The output voltage can directly be detected by a partial resistance. In this case, a resistance having a small allowable electric power value may be used as the partial resistance because a secondary side of the transformer has a low voltage. On the other hand, when the input voltage is directly detected by the partial resistance, it is necessary to use the resistance having a large allowable electric power value because a primary side of the transformer has a high voltage. This leads to an increase in cost and an obstacle of downsizing. Therefore, as disclosed in Domestic Re-publication of PCT International Publication No. 2009/011374 and Japanese Unexamined Patent Publication Nos. 2009-205299 and 9-135574, there is well known a method for estimating an input voltage based on a duty of a pulse signal (PWM signal) for driving a switching circuit.

FIG. 11 illustrates an example of a DC-DC converter according to the related art, which is mounted on an electric automobile or a hybrid car. A DC-DC converter 50 performs switching of a DC voltage of a high-voltage battery 63 and converts the DC voltage into a low-voltage direct current to charge a low-voltage battery 64.

The DC voltage of the high-voltage battery 63 is provided to a switching circuit 53 through a filter circuit 51. The switching circuit 53 includes a switching element that performs an ON/OFF operation using a PWM signal provided from a drive circuit 60. An output of the switching circuit 53 is provided to the primary side of a transformer 54. A rectifier circuit 55 including diodes D1 and D2 is connected to the secondary side of the transformer 54. A smoothing circuit 56, which includes a coil L and a capacitor C, is connected to an output side of the rectifier circuit 55. An output of the smoothing circuit 56 is a dropped DC voltage, and the low-voltage battery 64 is charged by the dropped DC voltage.

An auxiliary power supply 57 and an input current detection circuit 58 are provided on an input side of the switching circuit 53. The auxiliary power supply 57 is a power supply that drives a controller 59. The input current detection circuit 58 detects an input current Ii using a current sensor 52. A detection value of the current sensor 52 is provided to the controller 59. A temperature detection circuit 62 is provided for the purpose of temperature compensation, and a detection value of the temperature detection circuit 62 is provided to the controller 59.

An output voltage detection circuit 61 is provided to an output side of the smoothing circuit 56. The output voltage detection circuit 61 detects an output voltage Vo of the smoothing circuit 56. A detection value of the output voltage detection circuit 61 is provided to the controller 59 for the purpose of feedback control.

The controller 59 includes a microcomputer. The controller 59 compares the detection value of the output voltage Vo fed back from the output voltage detection circuit 61 to a target value, and generates an instruction value to bring the output voltage Vo in line with the target value based on a difference between the detection value and the target value. The instruction value is provided to the drive circuit 60.

The drive circuit 60 generates the PWM signal having a duty corresponding to the instruction value received from the controller 59, and drives the switching element of the switching circuit 53 using the PWM signal. The drive circuit 60 also outputs the generated PWM signal to the controller 59.

The controller 59 calculates a duty of the PWM signal by analyzing the PWM signal received from the drive circuit 60. The duty is a ratio of an ON time period in one cycle of the PWM signal. The controller 59 evaluates an input voltage Vi from the following equation using the calculated duty D and the output voltage Vo.

Vi=Vo·(N1/N2)/D (1)

where N1 is the number of turns of a primary-side coil of the transformer 54 and N2 is the number of turns of a secondary-side coil of the transformer 54.

The controller 59 evaluates an output current lo from the following equation using the input current Ii detected by the input current detection circuit 58.

Io=Ii(N1/N2) (2)

Thus, the input current Ii and the output voltage Vo are directly detected by the input current detection circuit 58 and the output voltage detection circuit 61, respectively. The input voltage Vi is evaluated from the equation (1) using the output voltage Vo and the duty D of the PWM signal, and the output current Io is evaluated from the equation (2) using the input current Ii.

However, in the related art, the input voltage Vi cannot correctly be calculated due to a variation of the duty D depending on the output current Io. This issue will be described below with reference to FIGS. 12A to 12D.

FIG. 12A illustrates a waveform of the PWM signal generated by the drive circuit 60, FIG. 12B illustrates a waveform of an ideal signal for used in the calculation of the correct duty, FIG. 12C illustrates a waveform of a primary-side voltage of the transformer 54, and FIG. 12D illustrates a waveform of a primary-side current of the transformer 54.

The direction of the current passing through the primary side of the transformer 54 is switched according to a switching operation of the switching circuit 53, and a commutation time period T indicated in FIG. 12D is necessary in order to switch the current direction because of an influence of leakage inductance of the transformer 54. The commutation time period T is proportional to the value of the output current lo, and the commutation time period T is lengthened as the value of the output current Io is increased. Because the controller 59 generates the instruction value of the duty in consideration of the commutation time period T, the PWM signal generated by the drive circuit 60 has the duty including a time period (hatched portion) corresponding to the commutation time period T as illustrated in FIG. 12A. As a result, because the duty of the PWM signal is varied according to the output current lo, an error is generated in a calculation result of the input voltage Vi from the equation (1) using such a duty, and the input voltage Vi cannot correctly be evaluated.

In order to correctly calculate the input voltage Vi, it is necessary to use a duty of the ideal signal as indicated in FIG. 12B, which is synchronized with the primary-side voltage of the transformer 54 indicated in FIG. 12C. However, the duty of the ideal signal indicated in FIG. 12B is hardly used in the device of the related art in which the duty is acquired from the PWM signal on the primary side of the transformer 54.

### SUMMARY

One or more embodiments of the present invention have been devised to provide a DC-DC converter that can correctly calculate an input voltage without being influenced by a commutation time period of a primary-side current of a transformer.

In accordance with one aspect of one or more embodiments of the present invention, a DC-DC converter includes: a transformer that has a primary winding and a secondary winding; a switching circuit that is connected to the primary winding of the transformer to perform switching of an input voltage; a drive circuit that drives the switching circuit; a rectifier circuit that rectifies an AC voltage generated in the secondary winding of the transformer according to the switching operation of the switching circuit; and a controller that evaluates a value of the input voltage and performs predetermined processing based on the value of the input voltage. The controller detects a pulse signal emerging on an input side or an output side of the rectifier circuit, calculates a duty of the pulse signal, and evaluates the value of the input voltage based on the calculated duty.

In the above configuration, because the duty is calculated based on the pulse signal on the input side or the output side of the rectifier circuit on the secondary side of the transformer, the duty is independent of the commutation time period of the primary-side current of the transformer. Accordingly, the input voltage calculated using the duty has the correct value that is not influenced by the commutation time period.

In the DC-DC converter according to one or more embodiments of the present invention, the controller may include: a pulse signal detector that detects the pulse signal emerging on the input side or the output side of the rectifier circuit; a duty calculator that calculates the duty of the pulse signal detected by the pulse signal detector; and an input voltage calculator that calculates the value of the input voltage based on the duty calculated by the duty calculator.

The DC-DC converter may further include: a smoothing circuit that smoothes an output of the rectifier circuit; and an output voltage detection circuit that detects an output voltage of the smoothing circuit, and further, the input voltage calculator may calculate the value of the input voltage based on the duty calculated by the duty calculator and a detection value of the output voltage detected by the output voltage detection circuit.

The DC-DC converter according to one or more embodiments of the present invention may further include a storage that has a table, in which the duty and the value of the input voltage are stored while being correlated with each other, and the controller may include: a pulse signal detector that detects the pulse signal emerging on the input side or the output side of the rectifier circuit; a duty calculator that calculates the duty of the pulse signal detected by the pulse signal detector; and an input voltage determination unit that refers to the table to extract the value of the input voltage corresponding to the duty based on the duty calculated by the duty calculator.

According to one or more embodiments of the present invention, the duty is acquired from the pulse signal on the secondary side of the transformer, so that the input voltage can correctly be calculated without being influenced by the commutation time period of the primary-side current of the transformer.

### BRIEF DESCRIPTION OF THE DRAWINGS

FIG. 1 is a circuit diagram of a DC-DC converter according to a first embodiment;

FIG. 2 is a flowchart illustrating an input voltage calculating procedure in the first embodiment;

FIGS. 3A to 3E are waveform charts of signals in the circuit in FIG. 1;

FIG. 4 is a circuit diagram of a DC-DC converter according to a second embodiment;

FIGS. 5A and 5B are waveform charts of pulse signals on an output side and an input side of a rectifier circuit;

FIG. 6 is a circuit diagram of a DC-DC converter according to a third embodiment;

FIG. 7 is a view of a table in which a duty and an input voltage are correlated with each other;

FIG. 8 is a flowchart illustrating an input voltage calculating procedure in the third embodiment;

FIG. 9 is a circuit diagram of a DC-DC converter according to a fourth embodiment;

FIG. 10 is a circuit diagram of a DC-DC converter according to a fifth embodiment;

FIG. 11 is a circuit diagram of a DC-DC converter of the related art; and

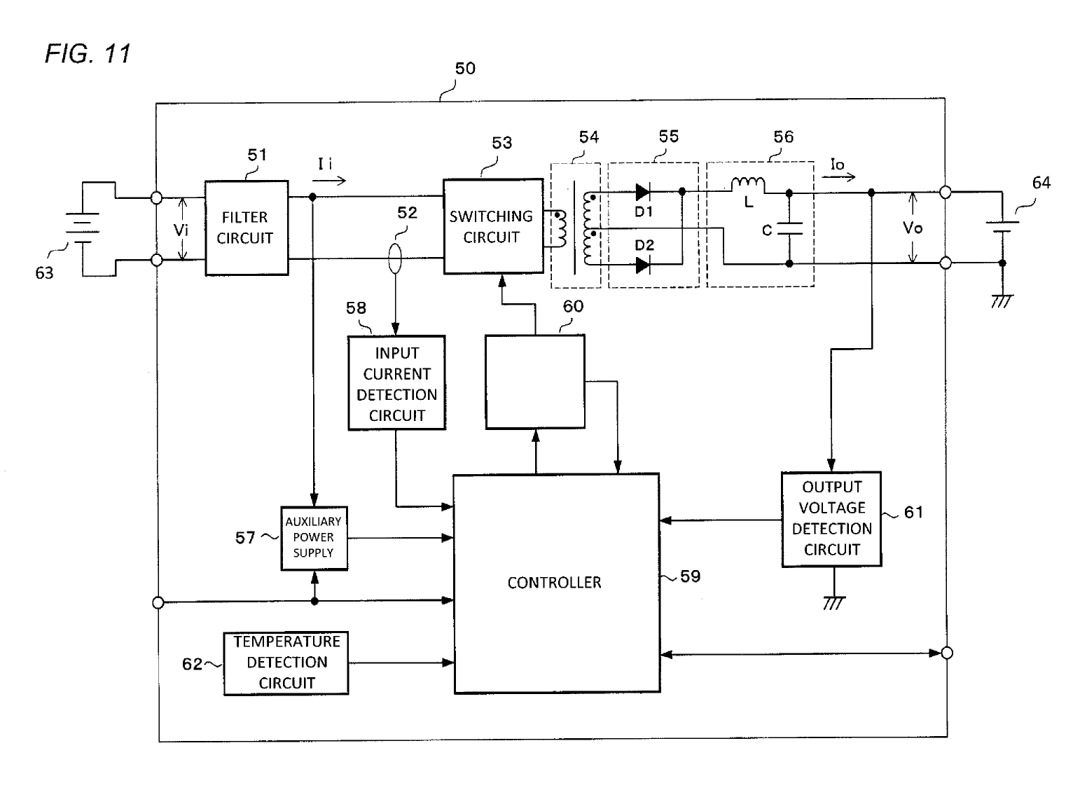

FIGS. 12A to 12D are waveform charts of signals in the circuit in FIG. 11.

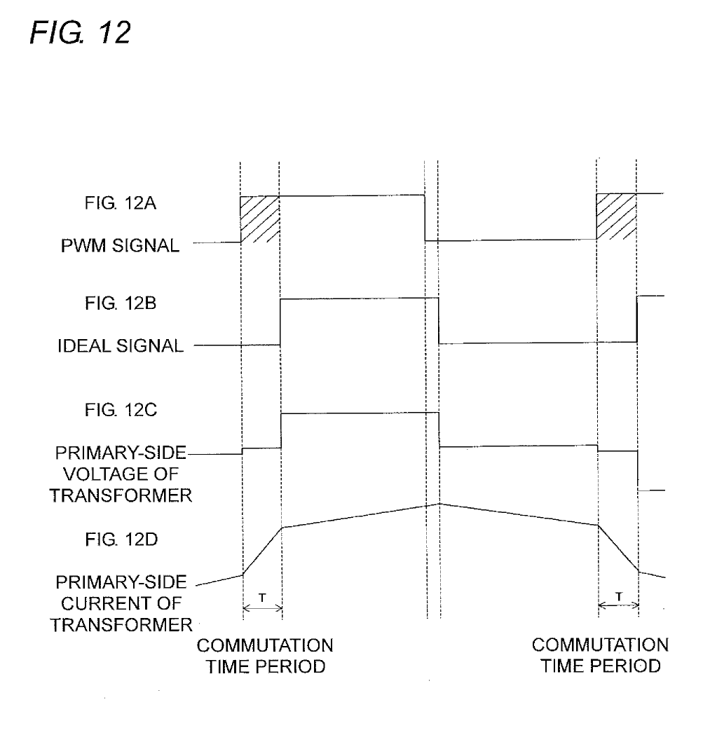

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention. A DC-DC converter mounted on an electric automobile or a hybrid car is described below by way of example.

### First Embodiment

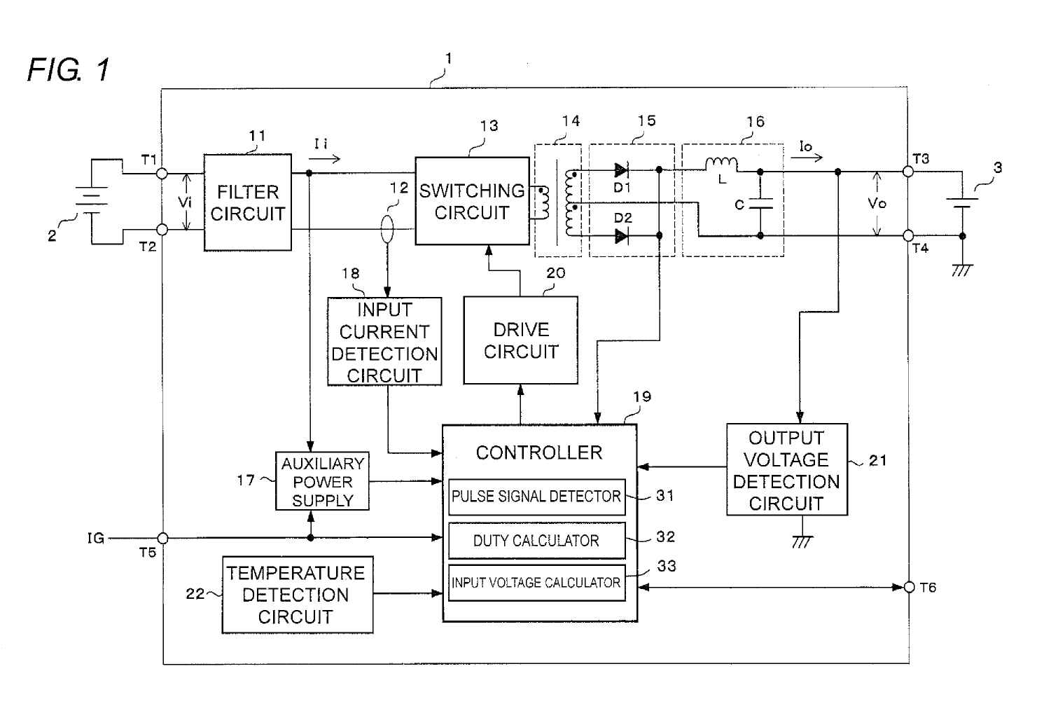

FIG. 1 illustrates a first embodiment of the present invention. A DC-DC converter 1 performs switching of a DC voltage of a high-voltage battery 2 and converts the DC voltage into a low-voltage current to charge a low-voltage battery 3. The high-voltage battery 2 is a power supply that drives a running motor of a vehicle. The low-voltage battery 3 is a power supply that drives various in-vehicle components (auxiliary machine).

The high-voltage battery 2 is connected to input terminals T1 and T2 of the DC-DC converter 1. The high-voltage battery 2 has a DC voltage from 220 V to 400 V, for example. An input voltage Vi that is applied to the input terminals T1 and T2 by the high-voltage battery 2 is input to a switching circuit 13 through a filter circuit 11.

The switching circuit 13 is a well-known circuit that is configured by bridge connection of switching elements such as a MOS-FET, as disclosed in Domestic Re-publication of PCT International Publication Nos. 2007/000830 and 2009/011374. The switching element performs ON and OFF switching operations using a PWM signal provided from a drive circuit 20.

An auxiliary power supply 17 and an input current detection circuit 18 are provided on an input side of the switching circuit 13. The auxiliary power supply 17 is a power supply that drives a controller 19. The input current detection circuit 18 detects an input current Ii using a current sensor 12. A detection value of the current sensor 12 is provided to the controller 19. A temperature detection circuit 22 is provided for the purpose of temperature compensation, and a detection value of the temperature detection circuit 22 is provided to the controller 19. An ignition signal IG is input to the controller 19 through a terminal T5. The ignition signal 1G is also provided to the auxiliary power supply 17. The controller 19 conducts communication with a superior apparatus (not illustrated) through a terminal T6.

A primary-side coil of a transformer 14 is connected to an output side of the switching circuit 13. A secondary-side coil of the transformer 14 is connected to an input side of a rectifier circuit 15 including diodes D1 and D2. A smoothing circuit 16, which includes a coil L and a capacitor C, is connected to an output side of the rectifier circuit 15. An output side of the smoothing circuit 16 is connected to output terminals T3 and T4. The low-voltage battery 3 is connected to the output terminals T3 and T4. An output of the smoothing circuit 16 is a dropped DC voltage, and the low-voltage battery 3 is charged to DC 12 V, for example, by an output voltage Vo output from the output terminals T3 and T4.

An output voltage detection circuit 21 is provided on the output side of the smoothing circuit 16. The output voltage detection circuit 21 detects the output voltage Vo of the smoothing circuit 16. The detection value of the output voltage detection circuit 21 is provided to the controller 19 for the purpose of feedback control.

The controller 19 includes a microcomputer. The controller 19 compares the detection value of the output voltage Vo fed back from the output voltage detection circuit 21 to a target value, and generates an instruction value to bring the output voltage Vo in line with the target value based on a difference between the detection value and the target value. The instruction value is provided to the drive circuit 20.

The drive circuit 20 generates a PWM signal having a duty corresponding to the instruction value from the controller 19, and drives the switching element of the switching circuit 13 using the PWM signal. The switching circuit 13 converts the DC voltage into a high-frequency AC voltage by an ON/OFF operation of the switching element. As a result, a pulse voltage is generated on the secondary side of the transformer 14. The pulse voltage is rectified by the rectifier circuit 15 and is smoothed by the smoothing circuit 16.

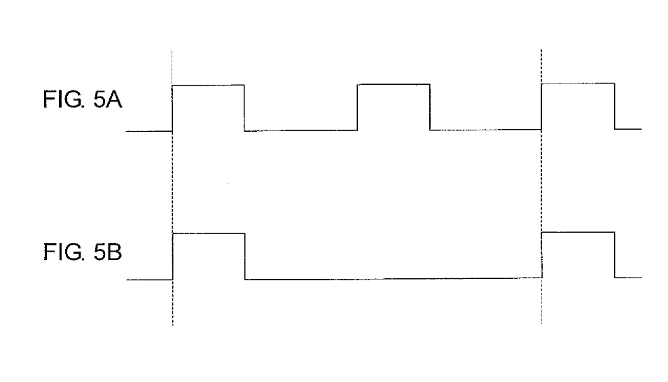

The output side of the rectifier circuit 15, namely, a connection point of cathodes of the diodes D1 and D2, is connected to the controller 19. The voltage emerging at the connection point is a pulse signal to which full-wave rectification is performed as illustrated in FIG. 5A. The controller 19 receives the pulse signal to acquire duty information.

The controller 19 includes a pulse signal detector 31, a duty calculator 32, and an input voltage calculator 33. The pulse signal detector 31 detects the pulse signal output from the rectifier circuit 15. The duty calculator 32 analyzes the pulse signal detected by the pulse signal detector 31, and calculates the duty of the pulse signal. The duty is a ratio of an ON time period in one cycle of the pulse signal. The input voltage calculator 33 evaluates the input voltage Vi from the following equation using a duty D′ calculated by the duty calculator 32 and the output voltage Vo.

Vi=Vo·(N1/N2)/D′ (3)

The equation (3) corresponds to the equation (1) mentioned earlier. N1 is the number of turns of the primary-side coil of the transformer 14 and N2 is the number of turns of the secondary-side coil of the transformer 14.

The controller 19 causes an input current calculator (not illustrated) to evaluate an output current Io from the following equation using the input current Ii detected by the input current detection circuit 18.

Io=Ii·(N1/N2) (4)

The equation (4) is identical to the equation (2) mentioned earlier.

As described above, the input current Ii and the output voltage Vo are directly detected by the input current detection circuit 18 and the output voltage detection circuit 21, respectively. The input voltage Vi is evaluated from the equation (3) using the output voltage Vo and the duty D′ of the pulse signal, and the output current Io is evaluated from the equation (4) using the input current Ii.

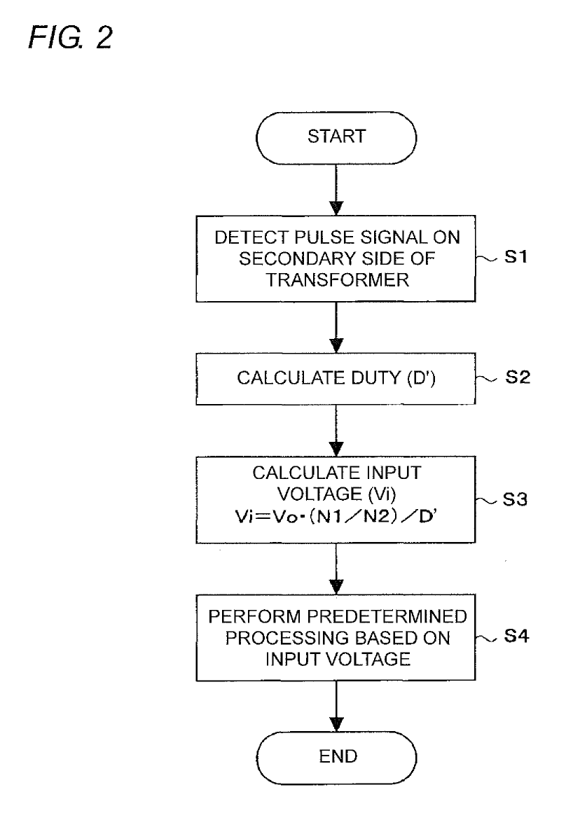

FIG. 2 is a flowchart illustrating a procedure of calculating the input voltage Vi. The controller 19 performs each of the steps. In Step S1, the pulse signal detector 31 detects the pulse signal on the secondary side (in the first embodiment, the output side of the rectifier circuit 15) of the transformer 14. In Step S2, the duty calculator 32 calculates the duty D′ of the pulse signal based on the pulse signal detected in Step S1. In Step S3, the input voltage calculator 33 calculates the input voltage Vi from the equation (3) using the duty D′ calculated in Step S1 and the output voltage Vo detected by the output voltage detection circuit 21. In Step S4, the controller 19 performs predetermined processing based on the input voltage Vi calculated in Step S3. For example, the controller 19 always monitors the input voltage Vi. When the input voltage Vi exceeds an upper-limit reference value or falls below a lower-limit reference value, the controller 19 determines that the high-voltage battery 2 is abnormal, and notifies the superior apparatus of the abnormality through the terminal T6.

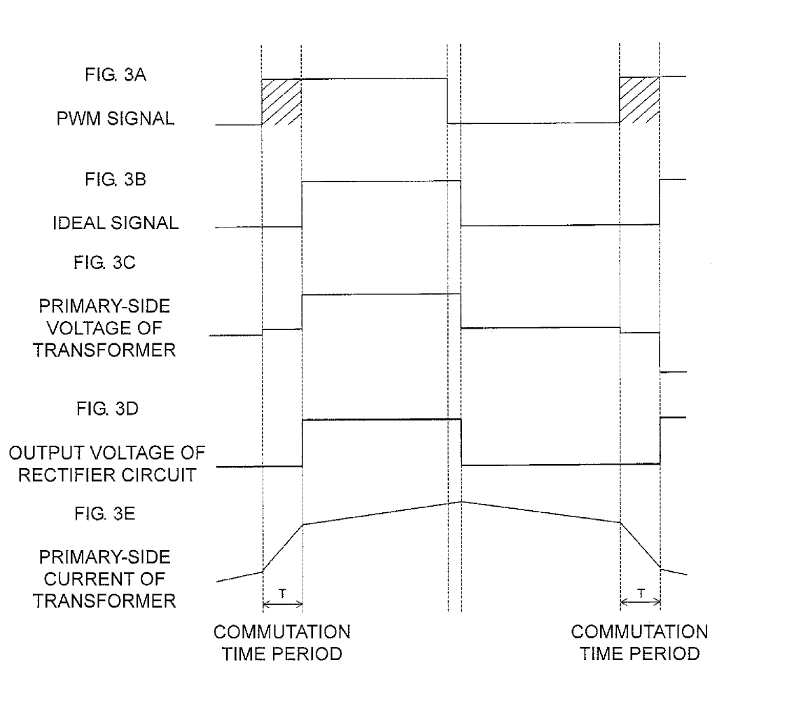

According to the first embodiment, because the duty is calculated based on the pulse signal on the output side of the rectifier circuit 15 on the secondary side of the transformer 14, the duty is independent of the commutation time period of the primary-side current of the transformer 14. The reason therefor will be described below with reference to FIGS. 3A to 3E.

FIG. 3A illustrates a waveform of the PWM signal generated by the drive circuit 20, FIG. 3B illustrates a waveform of an ideal signal for use in the calculation of the correct duty, FIG. 3C illustrates a waveform of a primary-side voltage of the transformer 14, FIG. 3D illustrates a waveform of the output voltage of the rectifier circuit 15, and FIG. 3E illustrates a waveform of the primary-side current of the transformer 14.

In the first embodiment, the input voltage Vi is calculated using the duty of the pulse signal indicated in FIG. 3D. As can be seen from FIG. 3D, the duty of the pulse signal is identical to the duty of the waveform of the ideal signal in FIG. 3B irrespective of a commutation time period T. Accordingly, the input voltage Vi, which is calculated using the duty, has a correct value independent of the influence of the commutation time period T.

According to the first embodiment, there is obtained the DC-DC converter that can correctly calculate the input voltage without being influenced by the commutation time period of the primary-side current of the transformer 14. Furthermore, it is not necessary to add a special component or a circuit, thereby not involving a complicated configuration or the increase in cost.

### Second Embodiment

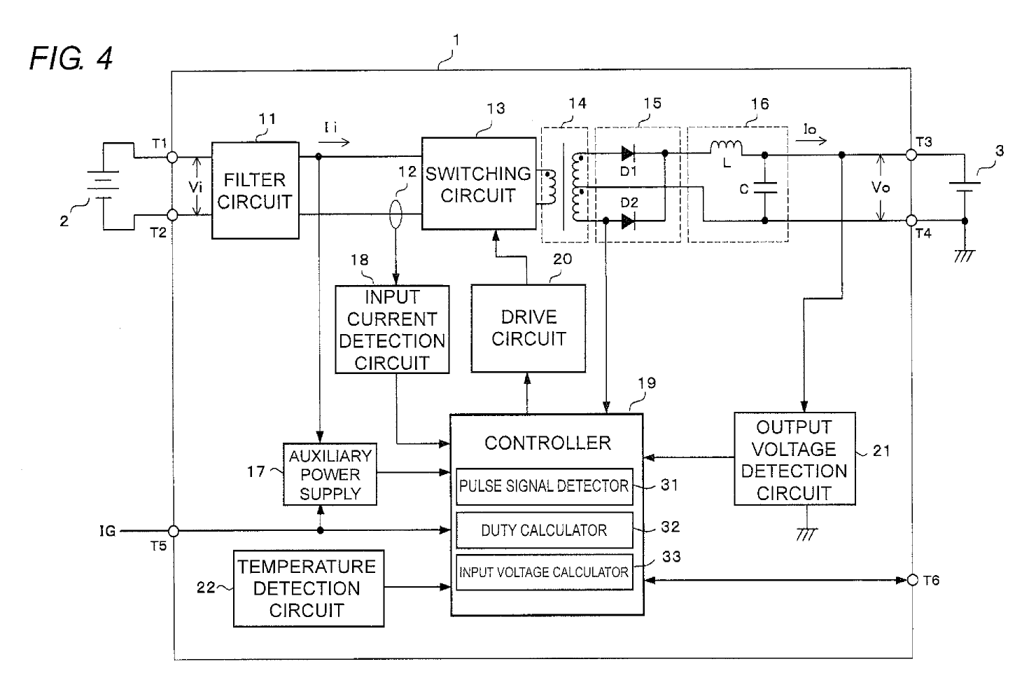

FIG. 4 illustrates a second embodiment of the present invention. In FIG. 4, the component identical or equivalent to that in FIG. 1 is designated by the reference sign identical to that in FIG. 1.

In the first embodiment in FIG. 1, the output side of the rectifier circuit 15 is connected to the controller 19. On the other hand, in the second embodiment in FIG. 4, the input side of the rectifier circuit 15, namely, an anode of the diode D2, is connected to the controller 19. Because the other portions of the configuration are identical to those in FIG. 1, the repetitive description is not provided.

In the second embodiment, the voltage emerging at the anode of the diode D2 is a pulse signal to which half-wave rectification is performed as illustrated in FIG. 5B. The controller 19 calculates the duty in a manner identical to that of the first embodiment based on the pulse signal, and evaluates the input voltage using the calculated duty and the output voltage (see FIG. 2). However, because the half-wave rectification is performed to the pulse signal, it is necessary to double the calculation result in the calculation of the duty. In this regard, the processing of the first embodiment is simpler than that of the second embodiment.

According to the second embodiment, because the duty is calculated based on the pulse signal on the input side of the rectifier circuit 15 on the secondary side of the transformer 14, the duty is independent of the commutation time period of the primary-side current of the transformer 14. Accordingly, the effect similar to that of the first embodiment can be obtained.

### Third Embodiment

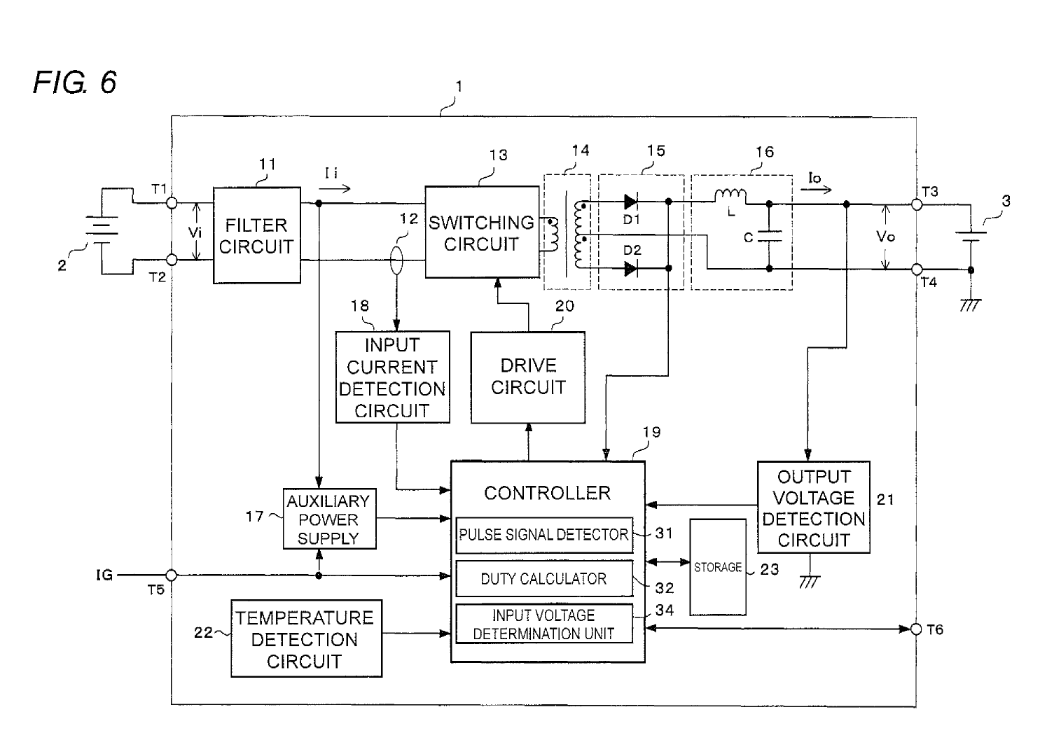

FIG. 6 illustrates a third embodiment of the present invention. In FIG. 6, the component identical or equivalent to that in FIG. 1 is designated by the reference sign identical to that in FIG. 1.

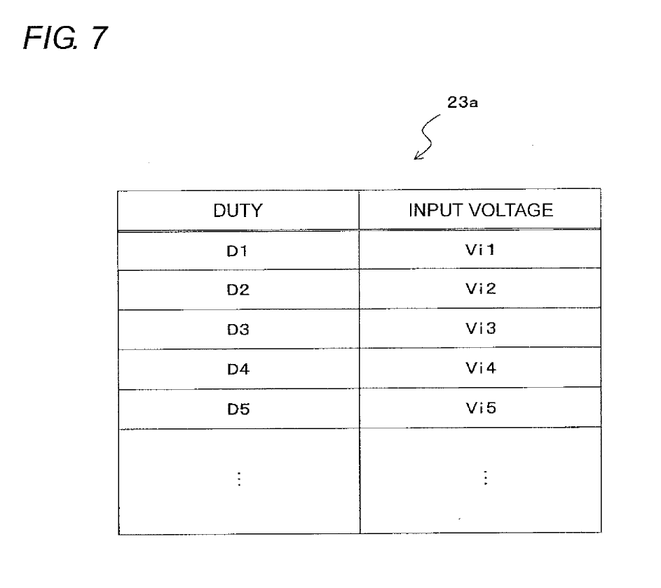

In FIG. 6, a storage 23 is added to the configuration of the first embodiment (FIG. 1). In the controller 19, an input voltage determination unit 34 is provided instead of the input voltage calculator 33 in FIG. 1. The storage 23 includes a table 23a as illustrated in FIG. 7. The duty and the input voltage are stored in the table 23a while being correlated with each other. Because the other portions of the configuration are identical to those in FIG. 1, the repetitive description is not provided.

In the first embodiment, the input voltage is evaluated from the calculation according to the equation (3) based on the duty calculated using the pulse signal on the output side of the rectifier circuit 15 and the output voltage. On the other hand, in the third embodiment, the value of the input voltage corresponding to the duty is evaluated by referring to the table 23a based on the duty calculated using the pulse signal on the output side of the rectifier circuit 15. Accordingly, the calculation according to the equation (3) is not necessary in the third embodiment.

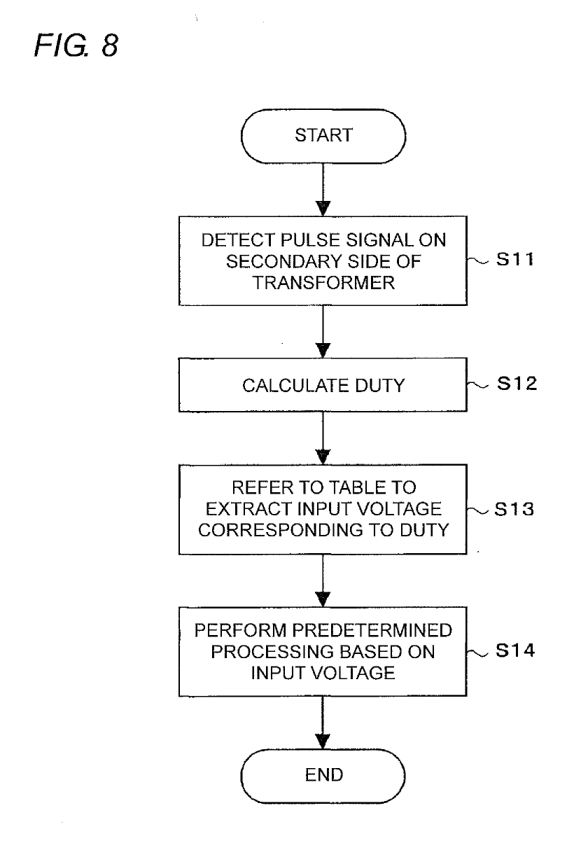

FIG. 8 is a flowchart illustrating the input voltage calculating procedure in the third embodiment. The controller 19 performs each of the steps. In Step S11, the pulse signal detector 31 detects the pulse signal on the secondary side (in the third embodiment, the output side of the rectifier circuit 15) of the transformer 14. In Step S12, the duty calculator 32 calculates the duty of the pulse signal based on the pulse signal detected in Step S11. In Step S13, the input voltage determination unit 34 refers to the table 23a to extract the input voltage corresponding to the duty calculated in Step S12. In Step S14, the controller 19 performs predetermined processing based on the input voltage extracted in Step S13. The content of the processing is identical to that of Step S4 in FIG. 2.

According to the third embodiment, because the duty is calculated based on the pulse signal on the output side of the rectifier circuit 15 on the secondary side of the transformer 14, the duty is independent of the commutation time period of the primary-side current of the transformer 14. Accordingly, the input voltage is extracted from the table 23a using the duty, so that the input voltage can correctly be evaluated. Moreover, the processing of calculating the input voltage is not necessary, thereby reducing a load on the controller 19.

### Fourth Embodiment

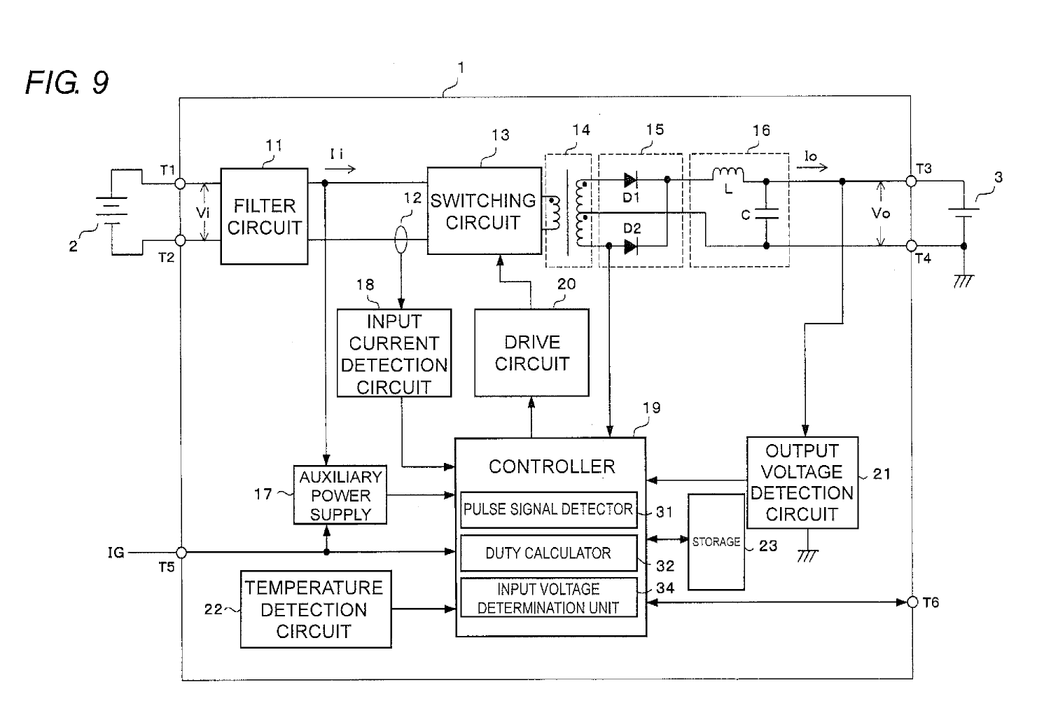

FIG. 9 illustrates a fourth embodiment of the present invention. In FIG. 9, the component identical or equivalent to that in FIG. 6 is designated by the reference sign identical to that in FIG. 6.

In FIG. 9, the storage 23 is added to the configuration of the second embodiment (FIG. 4). In the controller 19, the input voltage determination unit 34 is provided instead of the input voltage calculator 33 in FIG. 4. The storage 23 includes the table 23a shown in FIG. 7. Because the other portions of the configuration are identical to those in FIG. 4, the repetitive description is not provided.

In the fourth embodiment, in the manner identical to that illustrated in FIG. 8 except that the pulse signal is detected on the input side of the rectifier circuit 15, the duty is calculated, and the input voltage is extracted from the table 23a based on the calculated duty. Accordingly, the effect similar to that of the third embodiment can be obtained.

### Fifth Embodiment

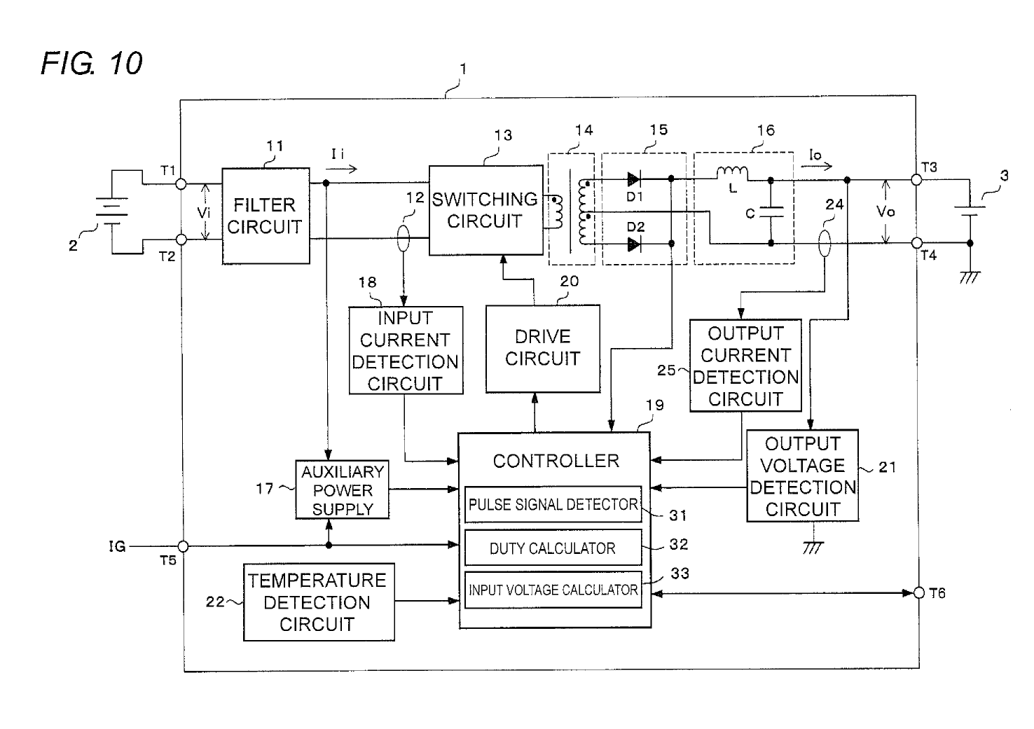

FIG. 10 illustrates a fifth embodiment of the present invention. In FIG. 10, the component identical or equivalent to that in FIG. 1 is designated by the reference sign identical to that in FIG. 1.

In FIG. 10, a current sensor 24 and an output current detection circuit 25 are added to the configuration of the first embodiment (FIG. 1). Because the other portions of the configuration are identical to those in FIG. 1, the repetitive description is not provided.

In the first embodiment, the output current lo is evaluated from the calculation according to the equation (4) using the input current Ii detected by the input current detection circuit 18. On the other hand, in the fifth embodiment, the output current detection circuit 25 directly detects the output current lo using the current sensor 24. The detection value of the output current detection circuit 25 is provided to the controller 19.

Although not illustrated, the current sensor 24 and the output current detection circuit 25 of FIG. 10 may be provided in the second embodiment (FIG. 4). The current sensor 24 and the output current detection circuit 25 of FIG. 10 may be also provided in the third embodiment (FIG. 6) and the fourth embodiment (FIG. 9).

Various embodiments in addition to the above embodiments can be made in the present invention. For example, in the above embodiments, the storage 23 is provided outside the controller 19 (FIGS. 6 and 9). Alternatively, the storage 23 may be provided in the controller 19.

In the above embodiments, the single controller 19 performs the feedback control of the output voltage Vo and the calculation of the input voltage Vi and the like. Alternatively, there may be provided a controller that performs the feedback control and a separate controller that performs the calculation of the input voltage Vi and the like.

In the above embodiments, the occurrence of the abnormality of the high-voltage battery 2 is monitored based on the evaluated input voltage Vi. Alternatively, for example, the output current lo may be evaluated by the calculation based on the input voltage Vi. In this case, the output current lo can be calculated from the following equation.

Io=Ii·Vi·η/Vo (5)

where η is a conversion efficiency.

In the above embodiments, the low-voltage battery 3 is charged by the DC voltage output from the DC-DC converter 1. Alternatively, the output of the DC-DC converter 1 may directly be supplied to the load.

In the above embodiments, by way of example, the DC-DC converter 1 is mounted on an electric automobile or a hybrid car. The DC-DC converter according to the present invention can also be applied to intended purposes other than the in-vehicle device.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A DC-DC converter comprising:
a transformer that comprises a primary winding and a secondary winding;
a switching circuit connected to the primary winding of the transformer to perform switching of an input voltage;
a drive circuit that drives the switching circuit;
a rectifier circuit that rectifies an AC voltage generated in the secondary winding of the transformer according to the switching operation of the switching circuit; and
a controller that evaluates a value of the input voltage and performs predetermined processing based on the value of the input voltage,
wherein the controller detects a pulse signal emerging on an input side or an output side of the rectifier circuit, calculates a duty of the pulse signal, and evaluates the value of the input voltage based on the calculated duty.

2. The DC-DC converter according to claim 1, wherein
the controller comprises:
a pulse signal detector that detects the pulse signal emerging on the input side or the output side of the rectifier circuit;
a duty calculator that calculates the duty of the pulse signal detected by the pulse signal detector; and
an input voltage calculator that calculates the value of the input voltage based on the duty calculated by the duty calculator.

3. The DC-DC converter according to claim 2, further comprising:
a smoothing circuit that smoothes an output of the rectifier circuit; and
an output voltage detection circuit that detects an output voltage of the smoothing circuit,
wherein the input voltage calculator calculates the value of the input voltage based on the duty calculated by the duty calculator and a detection value of the output voltage detected by the output voltage detection circuit.

4. The DC-DC converter according to claim 1, further comprising:
a storage that comprises a table, in which the duty and the value of the input voltage are stored while being correlated with each other,
wherein the controller comprises:
a pulse signal detector that detects the pulse signal emerging on the input side or the output side of the rectifier circuit;
a duty calculator that calculates the duty of the pulse signal detected by the pulse signal detector; and
an input voltage determination unit that refers to the table to extract the value of the input voltage corresponding to the duty based on the duty calculated by the duty calculator.
